(19) United States
(12) Patent Application Publication
(10) Pub. No.: US 2008/0138468 A1
(43) Pub. Date: Jun. 12, 2008

(54) Chrome-free fermentation products and preparing process thereof

(75) Inventor: Guo-Jane Tsai, Taipei City (TW)

Correspondence Address: BACON & THOMAS, PLLC, 625 SLATERS LANE, FOURTH FLOOR, ALEXANDRIA, VA, 22314, US

(73) Assignee: TENWELL BIOTECHNOLOGY LIMITED, Gueishan Township (TW)

(21) Appl. No.: 11/898,100

(22) Filed: Sep. 10, 2007

(30) Foreign Application Priority Data
Dec. 6, 2006 (TW) 095145301

(51) Int. Cl. A23L 1/28

(52) U.S. Cl. 426/62

(57) ABSTRACT

The present invention relates to chrome-free fermentation products, which are obtained by the fermentation of Saccharomyces cerevisiae. The fermentation products of the invention may effectively control the level of blood sugar, and useful to improve the normal metabolism of glucose and increase glucose tolerance when administered to non-insulin-dependent diabetes (NIDD) patients.

### FIELD OF THE INVENTION

The present invention relates to a chrome-free fermentation product, which is associated with the efficacy of improving the normal metabolism of glucose, increasing glucose tolerance and regaining the normal level of blood sugar.

### BACKGROUND OF THE INVENTION

Glucose tolerance factor (GTF) was firstly mentioned by Schwarz and Mertz in 1959. They discovered that chromic cation effected the exhibition of glucose tolerance in animal, and the extraction of chrome-containing materials from brewage yeast may improve the glucose intolerance occurred in rats fed with low-chrome feeds. So the extract was called “glucose tolerance factor”.

“Glucose tolerance” is defined as the recovery rate of raised glucose concentration after uptaken by mouth or injection to the normal level by effector cells taking glucose away from blood. Glucose tolerance factor may reduce the raised blood sugar to the normal level.

The metabolic convertion rate to GTF is decreasing by aging, it also occurred in diabetes patients. The long-term uptake of finely process foods may cause the insufficiency of materials required in GTF synthesis, which further results in decreased production of GTF and finally the resistance to insulin.

The sources of GTF are disclosed as follows, Toepfer et al, in J. Agri. Food. Chem. 25:162-165 (1977), reported that GTF is composed of trivalent chromium and nicotinic acid, Glu, Gly, and Cys. Haylock et al, in Journal of Inorganic Biochem. 18: 195-211 (1983), suggested that isolated GTF exhibits activity when carrying positive charge, and is partially active when carrying negative charge, both of them are free of chromium. U.S. Pat. No. 4,985,439 disclosed the isolation of GTF containing quinoline from autolyzed brewage yeast. Davies et al, in Biochem Med. 33(3):297-311 (1985), indicated that the negatively charged GTF contains chromium, while it is chrome-free when carrying positive charge. O'Donoghue et al, in Int J Biochem 22(8):841-6 (1990), reported the isolation of two negatively charged GTFs from autolyzed brewage yeast, both of them are free of chromium. Simonoff et al, in Cardiovasc Res. 18(10):591-6 (1992), suggested that the activity of GTF is independent of amounts of chromium. U.S. Pat. No. 4,923,855 disclosed the reaction of trivalent chromic salts with nicotinic acid, to obtain novel chrome containing products with GTF. Taiwan patent application NO. 88120636 disclosed the use of trivalent chromic complex obtained by the heat treatment of trivalent chromium and lactoferroprotein in controlling the levels of blood sugar, fats and cholesterol in NIDDM pateins.

In general, available GTFs are obtained from:

Yeast GTF
1. containing the materials with or without chromium.
2. useful in alleviating glucose intolerance.

Mammalian Low Molecular Weight Chrome-Containing Materials (LMWCr)
1. source from animal liver, kidney, and urine.
2. improve the glycolysis and convertion to lipids in lipocytes.
3. activate kinases in insulin receptor and the activity of Phosphotyrosine phosphotase (PTP) on cell membrane.

Synthetic Chrome-Containing Materials
1. with activities lower than yeast GTF.
2. precipitated at neutral pH value, unstable, and not easy for storage.
3. with side effects of malrecognition, failure of thought, and retadation.

While chromium is an essential element in the metabolism of glucose and lipids, the RDA (Recommend daily amount) of chromium by adult in USA is 50˜200 μg, long term uptake of excess chromium may result in ultra-burdens to kidney and liver. Chromium element could be further classified to divalent, trivalent, and hexavalent chromic compounds, among which the hexavalent chromium with strongest toxicity and easy to be absorbed. The intake amount of hexavalent chromium above 10 mg/kg may cause acute damages, such as bleeding in liver, kidney, and respiratory organs, as well as dermatitis. Moreover, there exist arguments in the accurate action of chromium in human body, for that no GTF had ever been isolated, and not reported any identification data for its structure. Therefore, the activity of chromium in glucose torlance is still unknown.

In general, Saccharomyces cerevisiae can produces GTF, but the product with low concentration and activity, so it has limited use in commercialization. Therefore, the GTF produced according to the invention by fermentating available in specified medium and at certain temperature, pH, and vigrating speed exhibits high productive level and activity. The present invention not only provides an manufacturing method of GTF at industrial scale, but also discloses the activity of produced GTF in modulating blood sugar in Streptozotocin (STZ)-induced diabetes mice to normal level.

### SUMMARY OF THE INVENTION

The present invention relates to a novel chrome-free GTF for controlling diabetes, which is obtained by the fermentation of Saccharomyces cerevisiae in specified medium, then centrifigation and ammonia spirit extraction and drying of precipitation after formentation.

The strain of Saccharomyces cerevisiae used in producting the chrome-free fermentation product of the invention is stored at Food Industry Research and Development Institute (Taiwan) with accession no. BCRC 21837.

The medium of the invention comprises reducing sugar at concentration of 0.5-8.5 g/L, 0.5-2.5% of carbon source, 0.05-0.3% of nitrogen source, and additional trace elements at concentration of 0.5-2 ppm. The carbon source may be selected from sucrose, fructose, glucose, meltose, lactose, galactose and the like. The nitrogen source may be selected from beef extract, casein, ammonium sulfate, ammonium nitrate and the like. The trace elements may be biotin or nicotinic acid.

The fermentation process of the present invention is performed at a condition of temperature 20-50° C., pH 2-7, and agitating rate of 70-150 rpm for 5 days.

The fermented liquid is centrifuged at high speed (10000-20000 rpm). Ammonia spirit is added to the precipitate at a ratio of prep.: ammonia=1:5, and then shaken at 25-40° C. at 100 rpm for 1-2 hr. and centrifuged at high speed 10000-20000 rpm again. The supernatant is dried to obtain fermentation product of the invention.

The drying process may be performed by lyophylization, vacuum drying, air drying and other drying methods.

According to the present invention, GTF obtained after purification of the fermentation product is a protein with molecular weight of 28-44 kDa, and is uncharged and chrome-free.

The activity of GTF obtained after purification of the fermentation product is decreased to 80-90% after treated at 60° C. for 30 min, while remained the same in the treatment of pH 2-11 for 30 min.

The blood sugar level in Streptozotocin (STZ)-induced diabetes mice is decreased by 100-115% after administered with the chrome-free fermentation product for 42 days, as compared to the untreated animals in control group.

The chrome-free fermentation product improves the activation of phosphotyrosine phosphatase (PTP) on cell membrane, which activates phosphatidylinositol-3-kinase (PI3Kinase), which further activates a downstream signal protein kinase B (PKB), then results in the migration of glucose transporter 4 (GLUT4) to cell membrane, and accelerates uptake and metabolism of glucose in cells. An alternative activation pathway of GLUT4 is by activating p38 mitogen-activated protein kinase (p38 MAPK) to accelerate the uptake and metabolism of glucose.

The chrome-free fermentation product may be made in foods or healthy foods, which may be eaten along or added to milk products or mixed with other food materials. Simple or complexed healthy foods may be made in a form of capsule, tablet and the like. The milk products include fresh milk, long life milk, condensed milk, cheese, and powdered milk.

The chrome-free fermentation product is administered to patients suffering from type II diabetes, for alleviating kinds of uncomfortable symptoms caused by diabetes.

### BRIEF DESCRIPTION OF THE FIGURES

FIG. 1 shows the result of DEAE cellulose column chromatography of a chrome-free fermentation product according to the present invention.

FIG. 2 shows the DOWEX 50WX8-200 column chromatography of DC1 elute isolated from the DEAE cellulose column.

FIG. 3 illustrates the improvement of individual elute from DEAE cellulose and DOWEX 50WX8-200 column chromatography in glucose uptake activity analyzed in 3T3-L1 cell model.

FIG. 4 shows the electrophoretogram of the chrome-free fermentation product isolate (DW1) obtained according to the present invention.

FIG. 5 illustrates the fluctuation in the level of blood sugar in diabetes mice induced by STZ after feeding with chrome-free fermentation product of the invention.

FIG. 6 illustrates the effects of PTP inhibitor sodium orthovanadate on the improvement of glucose uptake by the chrome-free fermentation product of the invention.

FIG. 7 illustrates the effects of PI3 kinase inhibitor wortmannin on the improvement of glucose uptake by the chrome-free fermentation product of the invention.

FIG. 8 illustrates the effects of PKC inhibitor bisindolylmaleimide on the improvement of glucose uptake by the chrome-free fermentation product of the invention.

FIG. 9 illustrates the effects of Akt/PKB inhibitor on the improvement of glucose uptake by the chrome-free fermentation product of the invention.

FIG. 10 illustrates the effects of p38 MAPK inhibitor SB203580 on the improvement of glucose uptake by the chrome-free fermentation product of the invention.

FIG. 11 illustrates the effects of the chrome-free fermentation product of the invention on the GLUT4 expression in cell membrane.

FIG. 12 illustrates the mechanism of chrome-free fermentation product of the invention acting in glucose metabolism.

### DETAILED DESCRIPTION OF THE INVENTION

The following examples are provided for illustrating the embodiments of present invention, and not intended to limit the scope of the invention.

### Example 1

The fermentation process was performed at temperature 25° C., pH 5 and agitating rate of 100 rpm for 5 days, with the culture medium composed of 1 weight % (wt %) of sucrose, 0.1 wt % of beef extract, and 0.5 ppm of biotin. The fermented culture is centrifuged at 10000 rpm. Ammonia spirit is added to the precipitate at a wt ratio of prep.:ammonia=1:5, and the mixture was shaken at 25-40° C. at 100 rpm for 1-2 hr. After then centrifugation was performed at 10000-20000 rpm again. The supernatant is lyophylized to dry.

### Example 2

The fermentation process was performed at temperature of 30° C., pH 6 and agitating rate of 130 rpm for 5 days, with the culture medium composed of 1 wt % of maltose, 0.1 wt % of casein, and 1.2 ppm of nicotinic acid. The fermented culture is centrifuged at 12000 rpm. Ammonia spirit is added to the precipitate at a wt ratio of prep.:ammonia=1:5, and the mixture was shaken at 25-40° C. at 100 rpm for 1-2 hr. After then centrifugation was performed at 10000-20000 rpm again. The supernatant is lyophylized to dry.

### Example 3

The fermentation process was performed at temperature of 20° C., pH 4 and agitating rate of 100 rpm for 5 days, with the culture medium composed of 1 wt % of fructose, and 0.1 wt % of ammonium sulfate. The fermented culture is centrifuged at 12000 rpm. Ammonia spirit is added to the precipitate at a wt ratio of prep.:ammonia=1:5, and the mixture was shaken at 25-40° C. at 100 rpm for 1-2 hr. After then centrifugation was performed at 10000-20000 rpm again. The supernatant is lyophylized to dry.

### Example 4

A chrome-free milk product was prepared by mixing the fermentation products obtained in example 1, 2, or 3 (in amount of 5 wt %) with powdered milk.

### Example 5

Chrome-free fresh milk was prepared by mixing the fermentation products obtained in example 1, 2, or 3 (in amount of 5 wt %) with fresh milk.

### Example 6

A chrome-free health food was prepared by mixing the fermentation products obtained in example 1, 2, or 3 with excipients and tabletting. The formulation is listed as follow:

| | |
|---|---|
| chrome-free fermentation product | 400 mg |
| microcrystalline cellulose | 95 mg |
| silica | 5 mg |

### Example 7

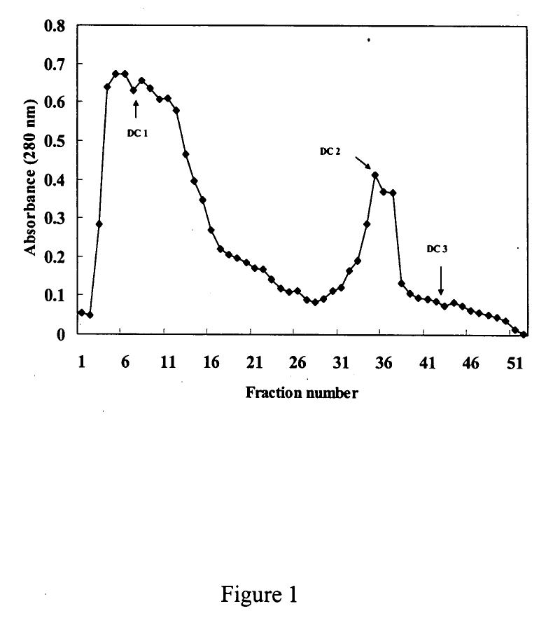

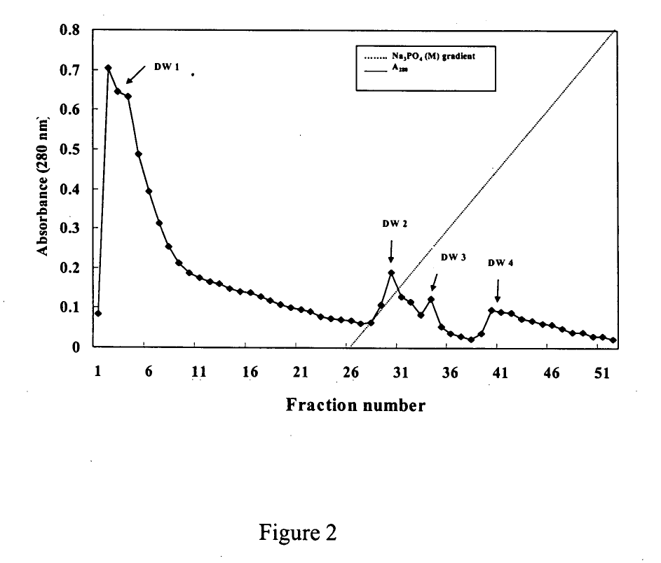

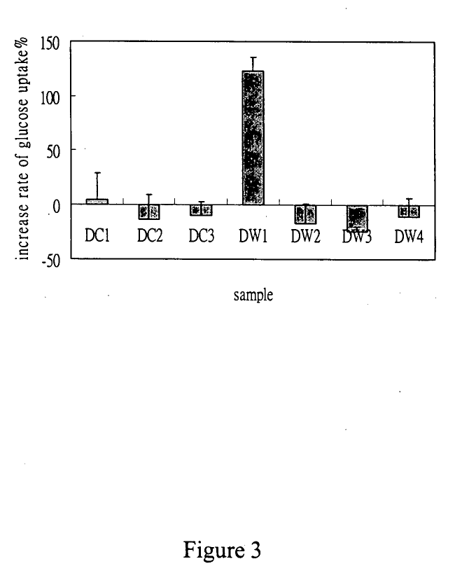

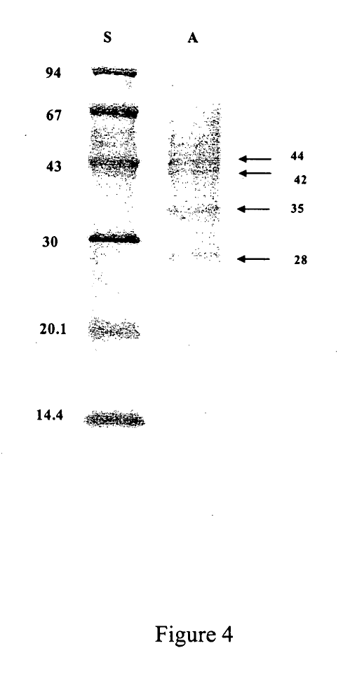

The purified fermentation product obtained in example by column chromatography exhibited an uncharged, chrome-free protein, with molecular weight of 28-44 kDa (showed in FIG. 1 to 4).

### Example 8

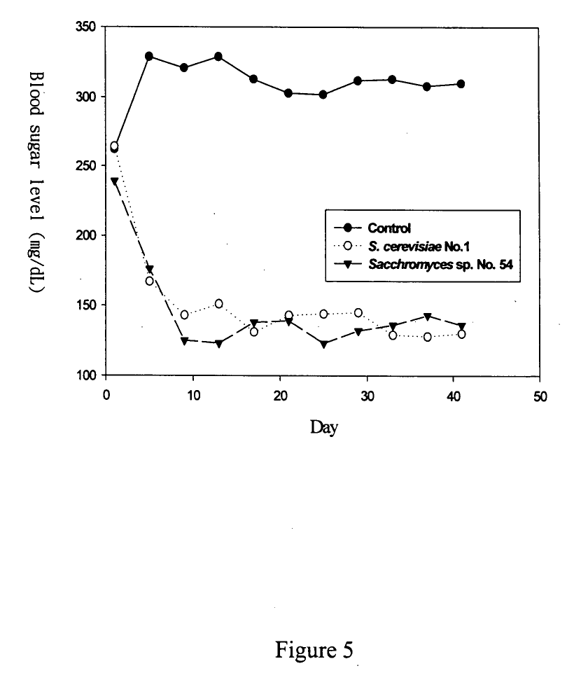

Changes of blood sugar level in Streptozotocin (STZ)-induced diabetes mice were determined with or without treatment of the chrome-free fermentation product. As showed in FIG. 5, blood sugar level of animals in treated group was significantly decreased after feeding with the product for 8 days, and was decreased by 107% after administered for 42 days, as compared to the control animals. This indicates that the fermentation product of this invention has a potancy to modulate blood sugar in STZ-induced diabetes mice to normal level.

### Example 9

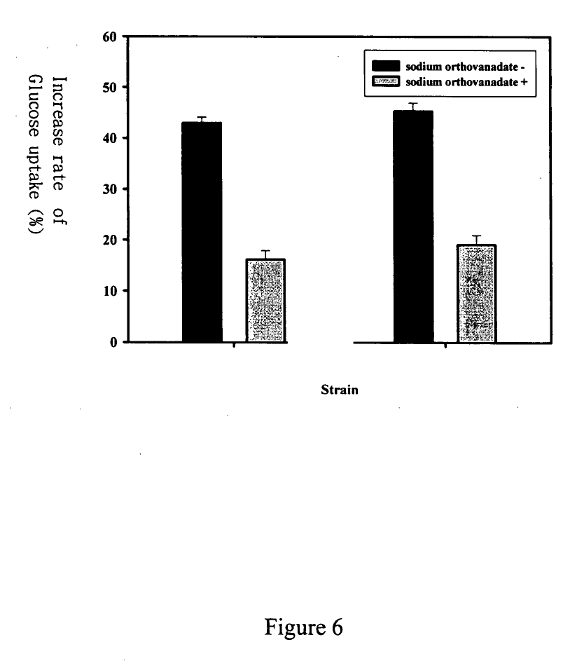

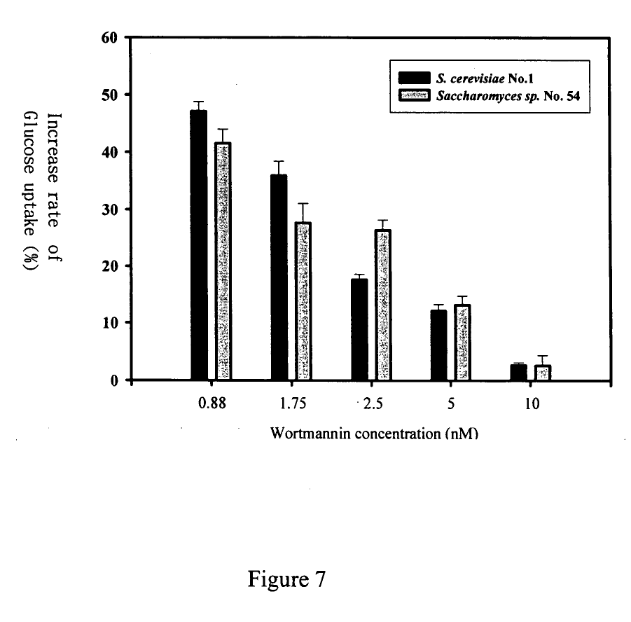

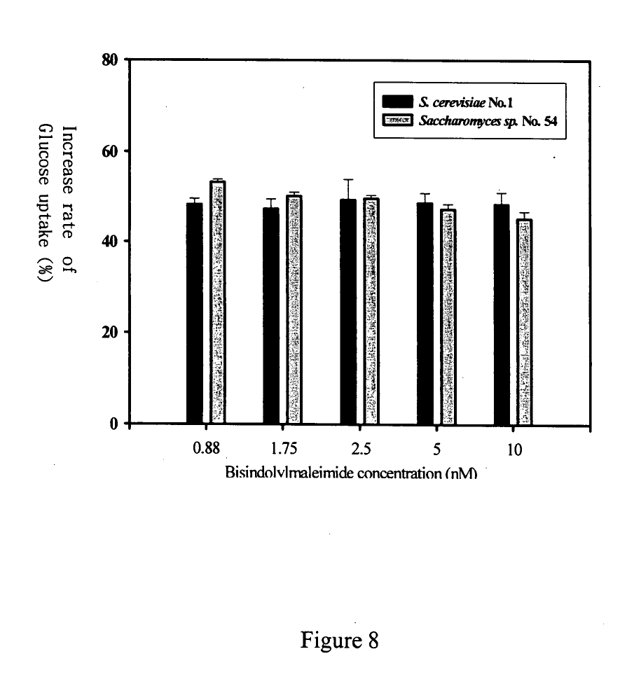

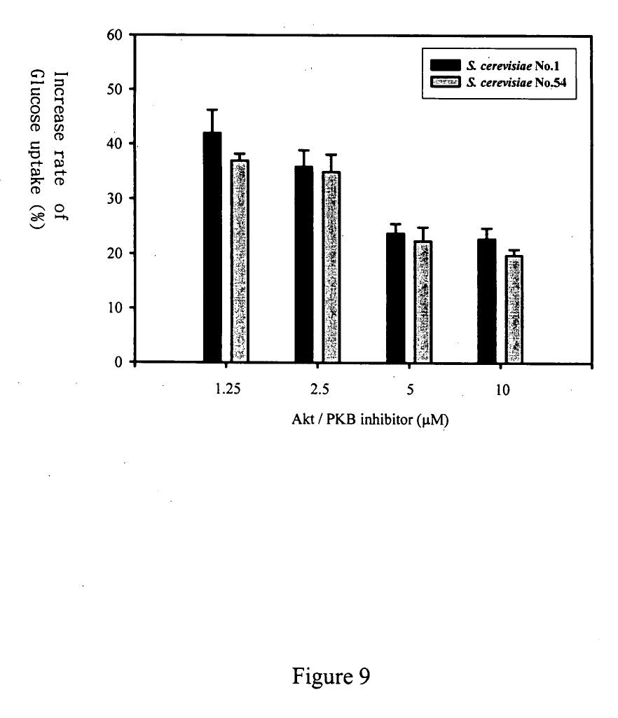

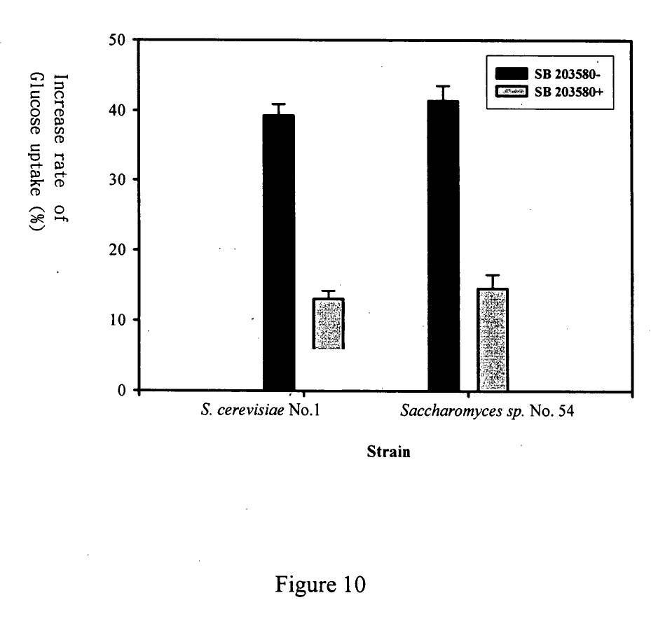

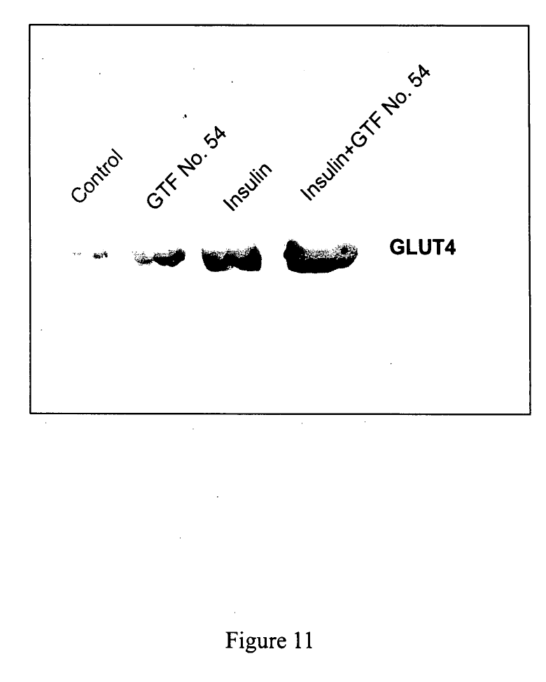

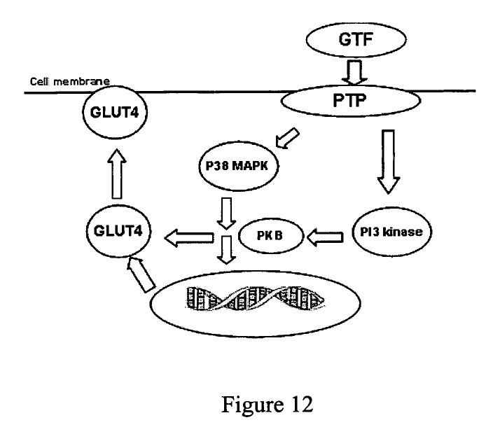

The mechanism of the chrome-free fermentation product function in regulating blood sugar, improving the normal metabolism of glucose, and increasing glucose tolerance was investigated. As showed in FIGS. 6 to 12, the product of the invention improves the activation of phosphotyrosine phosphatase (PTP) on cell membrane, which further activates PI3 Kinase, which then activates a downstream signal substance PKB, results in the migration of glucose transporter 4 (GLUT4) to cell membrane, and accelerates uptake and metabolism of glucose in cells. An alternative activation pathway of GLUT4 is by activating p38 mitogen-activated protein kinase (p38 MAPK) to accelerate the uptake and metabolism of glucose.

While this invention has been described in conjunction with specific embodiments and examples, it will be apparent to a person of ordinary skill in the art that variations or modifications in parts of the invention are intended to be included within the following claims.

1. A chrome-free GTF for controlling diabetes, which are obtained by fermentation of Saccharomyces cerevisiae in culture medium, centrifugation of fermented liquid, ammonia spirit extraction and drying of the precipitation.

2. A chrome-free GTF of claim 1, in which the Saccharomyces cerevisiae is a strain stored at Food Industry Research and Development Institute with accession NO. BCRC 21837.

3. A chrome-free GTF of claim 1, in which the culture medium comprising 0.5-8.5 g/L of reducing sugar, 0.5-2.5 wt % of carbon source, 0.05-0.3 wt % of nitrogen source, and additional trace elements at concentration of 0.5-2 ppm, and the carbon source may be selected from sucrose, fructose, glucose, meltose, lactose, galactose and the like; the nitrogen source may be selected from beef extract, casein, ammonium sulfate, ammonium nitrate and the like; and the trace elements may be biotin or nicotinic acid.

4. A chrome-free GTF of claim 1, in which the condition of fermentation comprising a temperature 20-50° C., pH 2-7, and agitating rate of 70-150 rpm for 5 days; and the fermented liquid is centrifuged at 10000-20000 rpm.

5. A chrome-free GTF of claim 1, in which ammonia spirit extraction comprising: Ammonia spirit addition to the precipitate at a weight ratio of prep.:ammonia=1:5; shaking at 25-40° C. at 100 rpm for 1-2 hr; one more centrifugation; and collection of the supernatant.

6. A chrome-free GTF of claim 1, in which the drying process is selected from lyophylization, vacuum drying, air drying, and any other drying method.
